(19) United States
(12) Patent Application Publication
(10) Pub. No.: US 2013/0320985 A1
(43) Pub. Date: Dec. 5, 2013

(54) APPARATUS AND METHOD FOR DIRECTIONAL RESISTIVITY MEASUREMENT WHILE DRILLING USING AN ANTENNA WITH A JOINT-COIL STRUCTURE

(71) Applicants: Ce Liu, Sugar Land, TX (US); Zhong Wang, Houston, TX (US); Suming Wu, Sugar Land, TX (US)

(72) Inventors: Ce Liu, Sugar Land, TX (US); Zhong Wang, Houston, TX (US); Suming Wu, Sugar Land, TX (US)

(21) Appl. No.: 13/489,191

(22) Filed: Jun. 5, 2012

(51) Int. Cl. G01V 3/12

(52) U.S. Cl. CPC G01V 3/12
USPC 324/339; 324/334

(57) ABSTRACT

An apparatus for making directional resistivity measurements of a subterranean formation includes a resistivity tool with a longitudinal axis and an outer surface, a first antenna deployed below the outer surface and having an axial mode coil for processing an axial electromagnetic wave and a transverse mode coil for processing a transverse electromagnetic wave to form a joint-coil structure, a second antenna deployed below the outer surface and spaced at an axial distance from the first antenna, at least two sets of slots with different orientations formed on the outer surface. A corresponding method for making directional resistivity measurements includes rotating a resistivity tool in a borehole, utilizing a transmitter-receiver antenna group formed in the resistivity tool to process a superimposition of the axial and transverse electromagnetic waves, and computing a resistivity-related measurement from the superimposition of the axial and transverse electromagnetic waves received on the receiver antenna.

### FIELD OF THE INVENTION

The present invention relates generally to the field of electrical resistivity well logging. More particularly, the invention relates to an apparatus and a method for providing a directional resistivity tool with a joint-coil antenna to make directional resistivity measurements of a subterranean formation.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation.

Ordinarily, a well is drilled vertically and is substantially perpendicular to the layers of geological formation. A LWD or MWD tool for measuring the resistivity of the surrounding formation does not need to be azimuthally designed, as the formation surrounding the borehole is essentially the same in all directions. The rotation of LWD or MWD tool has no significant effect on the measured resistivity. For this reason, a conventional resistivity tool usually includes a receiver coil spaced at various axial distances from one or more transmitter coils as shown in FIG. 1A, and both receiver and transmitter coils are oriented so as to transmit/receiver axial electromagnetic waves in the direction parallel to the longitudinal axis of the resistivity tool. Alternating current in the transmitter coil produces corresponding alternating electromagnetic fields in the formation. Voltages are induced on the receiver coil as a result of electromagnetic induction phenomena related to the alternating electromagnetic fields induced in the formation surrounding the borehole. The measured voltage can be processed, as known in the prior art, to estimate formation resistivity.

However, a “horizontal drilling,” which means drilling wells at less of an angle with respect to the geological formation, is getting popular because it can increase exposed length of the pay zone (the formation with hydrocarbons) and overcome difficulties of vertical drilling. When drilling horizontally, it is preferable to keep the borehole in the pay zone as much as possible so as to maximize the recovery. Therefore, a directional resistivity tool with azimuthal sensitivity is needed to make steering decisions for subsequent drilling of the borehole. The steering decisions can be made upon measurement results of bed boundary identification, formation angle detection, and fracture characterization.

Directional resistivity measurements commonly involve transmitting and/or receiving transverse (x-mode or y-mode) or mixed mode (e.g. mixed x- and z-mode) electromagnetic waves. Various antenna configurations are well known for making such measurements, such as a transverse antenna configuration (x-mode) shown in FIG. 1B, a bi-planer antenna configuration shown in FIG. 1C, a saddle antenna configuration (x-mode and z-mode, mixed mode) shown in FIG. 1D, and a tilted antenna shown in FIG. 1E.

As described above, although the directional resistivity tools have been used commercially, a need still exists for an improved antenna configured in a directional resistivity tool.

A further need exists for an improved antenna configuration which can receive axial (z-mode) electromagnetic waves and transverse (x- and/or y-mode) electromagnetic waves, and both of the axial and transverse electromagnetic waves can be superimposed for making directional or/and non-directional resistivity measurement.

A further need exists for an improved antenna configuration which can provide mechanical strength of the mandrel of the directional resistivity tool and facilitate propagation of electromagnetic waves.

The present embodiments of the apparatus and the method meet these needs, and improve on the technology.

### SUMMARY OF THE INVENTION

This section provides a general summary of the disclosure, and is not a comprehensive disclosure of its full scope or its entire feature.

In on preferred embodiment, an apparatus for making directional resistivity measurements of a subterranean formation includes a resistivity tool with a longitudinal axis and an outer surface, a first antenna deployed below the outer surface and having an axial mode coil and a transverse mode coil to form a joint-coil structure for processing signals, a second antenna deployed below the outer surface and spaced at an axial distance from the first antenna, and at least two sets of slots formed on the outer surface. The axial mode coil has a central axis which is substantially parallel to the longitudinal axis of the resistivity tool. The transverse mode coil has a central axis which is substantially perpendicular to the longitudinal axis of the resistivity tool. The first set of slots is oriented differently from the second set of slots.

In some embodiments, the axial mode coil processes an axial electromagnetic wave.

In some embodiments, the transverse mode coil processes a transverse electromagnetic wave.

In some embodiments, the joint-structure is configured in a way that the signals processed by the axial mode coil and the signals processed by the transverse mode coil are superimposed.

In some embodiments, the first antenna operates as a transmitter antenna to transmit an electromagnetic wave or as a receiver antenna to receive the electromagnetic wave.

In some embodiments, the second antenna operates as the receiver antenna while the first antenna operates as the transmitter antenna.

In some embodiments, the second antenna operates as the transmitter antenna while the first antenna operates as the receiver antenna.

In some embodiments, the second antenna is a wire loop deployed substantially perpendicular to the longitudinal axis of the resistivity tool.

In some embodiments, the axial mode coil is a wire loop deployed substantially perpendicular to the longitudinal axis of the resistivity tool.

In other embodiments, the transverse mode coil has two axial wire segments and two circumferential wire segments.

In other embodiments, one of the circumferential wire segments is connected with the axial mode coil.

In other embodiments, the second set of slots is oriented substantially parallel to the longitudinal axis of the resistivity tool.

In still other embodiments, the first set of slots is formed in two rows and oriented substantially perpendicular to the longitudinal axis of the resistivity tool.

In still other embodiments, the pathway of the first antenna traverses the two sets of slots.

In another embodiment, the apparatus further includes a permeable material filled in the slots.

In another embodiment, the permeable material is a magnetic material for enhancing transmission and reception of the first antenna and the second antenna.

In another embodiment, the magnetic material is selected from the group consisting of a ferrite material, an electrically non-conductive magnetic alloy, an iron powder, and a nickel iron alloy.

In still another embodiment, the apparatus further includes a protective material filled in the slots.

In still another embodiment, the protective material is made of epoxy resin.

In another preferred embodiment, an apparatus for making directional resistivity measurements of a subterranean formation includes a resistivity tool with a longitudinal axis and at least two recessed regions, a first antenna placed in the recessed region and having an axial mode coil and a transverse mode coil to form a joint-coil structure to receive or transmit an electromagnetic wave, a second antenna placed in the recessed region of the resistivity tool body, spaced at an axial distance from the first antenna, and configured to transmit or receive the electromagnetic wave to or from the first antenna, and at least one slot shield having two sets of slots formed on the recessed regions to cover the first antenna and the second antenna for mechanical protection and facilitating the propagation of the electromagnetic wave. The axial mode coil is for processing an axial electromagnetic wave. The transverse mode coil is for processing a transverse electromagnetic wave. The first set of slots is oriented differently from the second set of slots.

In still another preferred embodiment, a method for making directional resistivity measurements of a subterranean formation includes rotating a resistivity tool in a borehole, the resistivity tool including a first antenna having an axial mode coil for processing an axial electromagnetic wave and a transverse mode coil for processing a transverse electromagnetic wave to form a joint-coil structure, a second antenna, and the first antenna and the second antenna forming a transmitter-receiver antenna group having a transmitter antenna and a receiver antenna, utilizing the transmitter-receiver antenna group to process a superimposition of the axial electromagnetic wave and the transverse electromagnetic wave, including causing the transmitter antenna to transmit the superimposition of the axial electromagnetic wave and the transverse electromagnetic wave and causing the receiver antenna to receive the superimposition of the axial electromagnetic wave and the transverse electromagnetic wave from the transmitter antenna, and computing a resistivity-related measurement from the superimposition of the axial electromagnetic wave and the transverse electromagnetic wave on the receiver antenna.

In some embodiments, computing the resistivity-related measurement includes extracting an average value of induced voltages on the receiver antenna during a rotation round of the resistivity tool.

In some embodiments, computing the resistivity-related measurement further includes processing the average value of induced voltages to derive a resistivity of the subterranean formation adjacent to the borehole.

In other embodiments, computing the resistivity-related measurement includes extracting a peak-valley amplitude of induced voltages on the receiver antenna during a rotation round of the resistivity tool and a rotation angle.

In another embodiment, computing the resistivity-related measurement further includes processing the peak-valley amplitude to derive an information of distance and direction to an interface from the resistivity tool.

In still another preferred embodiment, an apparatus for making directional resistivity measurements of a subterranean formation includes a resistivity tool with a longitudinal axis and an outer surface, a first antenna deployed below the outer surface and formed by a single wire for processing signals, a second antenna deployed below the outer surface and spaced at an axial distance from the first antenna, and at least two sets of slots formed on the outer surface. The single wire is folded into a shape with at least an axial loop and at least a transverse loop. The axial loop has a central axis substantially parallel to the longitudinal axis of the resistivity tool and is for processing an axial electromagnetic wave. The transverse loop has a central axis substantially perpendicular to the longitudinal axis of the resistivity tool and is for processing a transverse electromagnetic wave. The first set of slots is oriented differently on the outer surface from the second set of slots.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1A illustrates a prior art of a conventional resistivity tool with a pair of a transmitter antenna and a receiver antenna.

FIGS. 1B, 1C, 1D, and 1E illustrate prior arts of antenna embodiments for making directional resistivity measurements.

FIG. 2 illustrates a front view of a directional resistivity tool assembled with a conventional logging while drilling system.

FIG. 3A illustrates a perspective view of the directional resistivity tool shown in FIG. 2 according to some embodiments of the present invention.

FIG. 3B illustrates an enlarged view of the first antenna shown in FIG. 3A.

FIG. 3C illustrates an enlarged view of the second antenna shown in FIG. 3A.

FIG. 4A illustrates a perspective view of the directional resistivity tool with multiple slots according to some embodiments of the present invention.

FIG. 4B illustrates a cross-sectional view of the directional resistivity tool 212 taken along line AA′ in FIG. 4A.

FIG. 4C illustrates an explored view of the directional resistivity tool with recessed regions and slot shields.

FIG. 5 illustrates a model used for demonstrating the azimuthal sensitivity of the present invention.

FIG. 6A illustrates simulation results of the model in FIG. 5 in term of a data graph of the real part of the induced voltage of the first antenna shown in FIG. 3A versus rotation angle of the directional resistivity tool.

FIG. 6B illustrates simulation results of the model in FIG. 5 in term of a data graph of the imaginary part of the induced voltage of the first antenna shown in FIG. 3A versus rotation angle of the directional resistivity tool.

FIG. 6C illustrates simulation results of the model in FIG. 5 in term of a data graph of the amplitude of the induced voltage of the first antenna shown in FIG. 3A versus rotation angle of the directional resistivity tool.

FIG. 7A illustrates simulation results of the model in FIG. 5 in term of a data graph of the real part of the induced voltage of the third antenna shown in FIG. 3A versus rotation angle of the directional resistivity tool.

FIG. 7B illustrates simulation results of the model in FIG. 5 in term of a data graph of the imaginary part of the induced voltage of the third antenna shown in FIG. 3A versus rotation angle of the directional resistivity tool.

FIG. 7C illustrates simulation results of the model in FIG. 5 in term of a data graph of the amplitude of the induced voltage of the third antenna shown in FIG. 3A versus rotation angle of the directional resistivity tool.

FIG. 8A illustrates simulation results of the model in FIG. 5 in terms of a data graph of the average induced voltage of the first antenna and of the third antenna shown in FIG. 3A versus distance to resistivity interface.

FIG. 8B illustrates simulation results of the model in FIG. 5 in terms of a data graph of the amplitude ratio of the average induced voltage of the first antenna to the average induced voltage of the third antenna shown in FIG. 3A versus distance to resistivity interface.

FIG. 8C illustrates simulation results of the model in FIG. 5 in terms of a data graph of the phase difference between the average induced voltage of the first antenna and the average induced voltage of the third antenna shown in FIG. 3A versus distance to resistivity interface.

FIG. 9A illustrates simulation results of a model in which the directional resistivity tool is embedded in a homogenous formation with varying resistivity in terms of a data graph of the amplitude ratio of the induced voltage of the first antenna to the induced voltage of the third antenna shown in FIG. 3A versus resistivity of the surrounding formation.

FIG. 9B illustrates simulation results of the model in terms of a data graph of the phase difference between the induced voltage of the first antenna and the induced voltage of the third antenna shown in FIG. 3A versus resistivity of surrounding formation.

FIG. 10 illustrate a perspective view of an antenna with a C-shaped coil design according to other embodiments of the present invention.

FIG. 11 illustrate a perspective view of an antenna with an L-shaped coil design according to other embodiments of the present invention.

FIG. 12 illustrates a flow chart of making directional resistivity measurements according to some embodiments of the present invention.

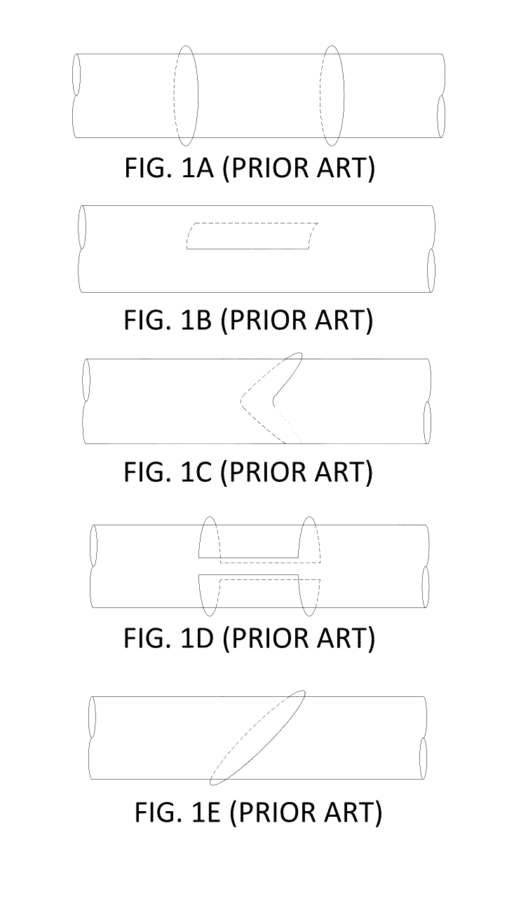

The present embodiments are detailed below with reference to the listed Figures.

### DETAILED DESCRIPTION OF THE EMBODIMENTS

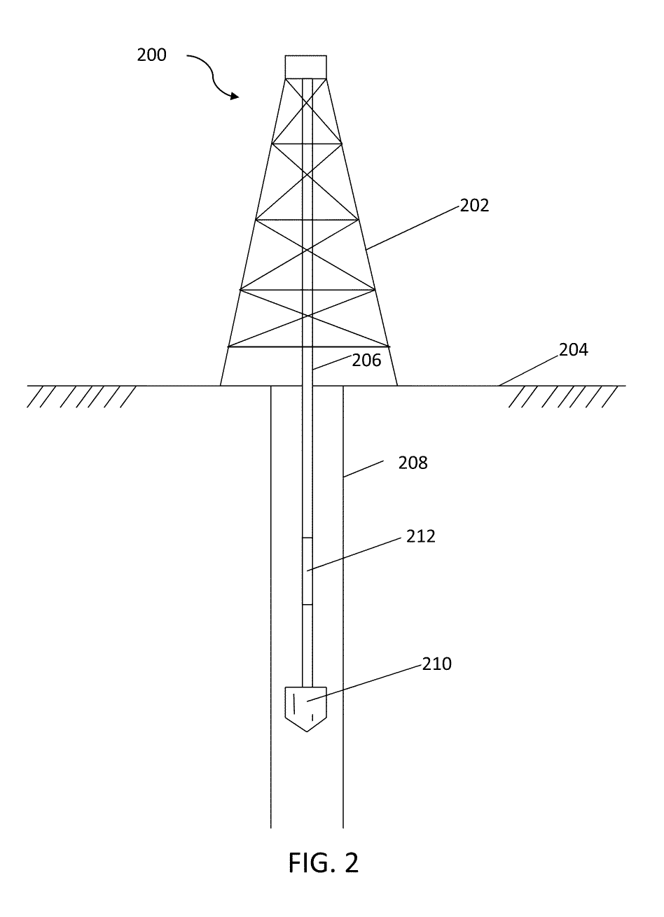

FIG. 2 illustrates a front view of a directional resistivity tool 212 assembled with a conventional logging while drilling system 200 according to some embodiments of the present invention. The conventional logging while drilling system 200 can include a drilling rig 202, a drill string 206, a drill bit 210, and a directional resistivity tool 212. The drill string 206 supported by the drilling rig 202 can extend from above a surface 204 down into a borehole 208. The drill string 206 can carry on the drill bit 210 and the directional resistivity tool 212 to make measurements of geological properties of a subterranean formation while drilling.

In some embodiments, the drill string 206 can further include a mud pulse telemetry system, a borehole drill motor, measurement sensors, such as a nuclear logging instrument, and an azimuth sensor, such as an accelerometer, a gyroscope, or a magnetometer, for facilitating measurements of surrounding formation. Also, the drill string 206 can be assembled with a hoisting apparatus for elevating or lowering the drill string 206.

The directional resistivity tool 212 according to the present invention can be applied not only to a logging while drilling (“LWD”) system, but also to a measurement while drilling (“MWD”) system and wireline applications. Also, the directional resistivity tool 212 can be equally suited for use with any kind of drilling environment, either onshore or offshore, and with any kind of drilling platform, including but not limited to, fixed, floating, and semi-submerge platforms.

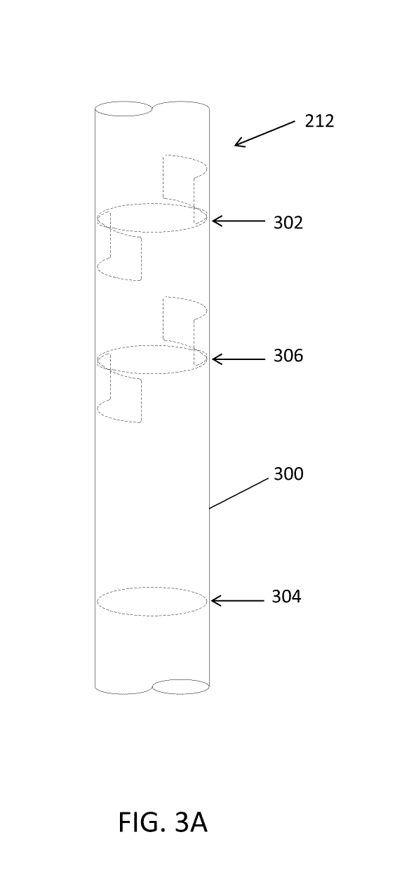

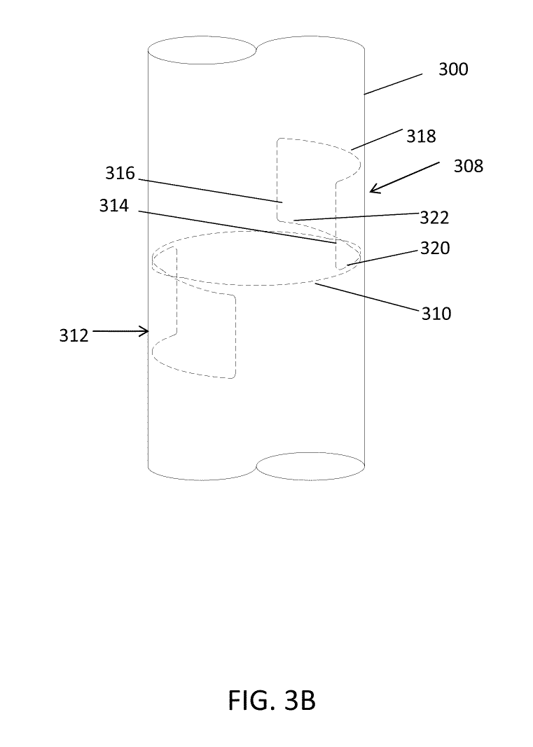

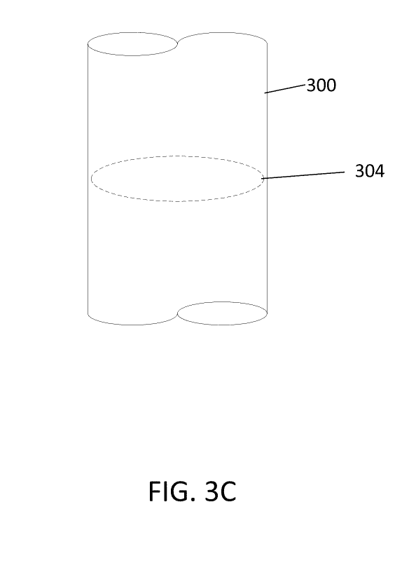

FIG. 3A illustrates a perspective view of the directional resistivity tool 212 shown in FIG. 2 according to some embodiments of the present invention. The directional resistivity tool 212 can include a first antenna 302, a second antenna 304, and optionally a third antenna 306. The first antenna 302, the second antenna 304, and the optional third antenna 306 can be deployed below the outer surface 300 of the directional resistivity tool 212 and spaced at axial distance from each other.

FIG. 3B illustrates an enlarged view of the first antenna 302 shown in FIG. 3A.

The first antenna 302, which can be structurally similar to the third antenna 306, can have transverse mode coils (x-mode and/or y-mode) 308 and 312 and an axial mode coil (z-mode) 310 to form a joint-coil structure for processing axial and transverse electromagnetic waves. The axial mode coil 310 can have a central axis which is substantially parallel to the longitudinal axis of the directional resistivity tool 212. The transverse mode coils 308 and 312 can have central axes which are substantially perpendicular to the longitudinal axis of directional resistivity tool 212. The first antenna 302 with the joint-structure can be configured in a way that the processed axial and transverse electromagnetic waves can be superimposed.

The axial mode coil 310 can be a wire loop deployed substantially perpendicular to the longitudinal axis of directional resistivity tool 212. The transverse mode coil 308 (as well as the transverse mode coil 312) can have two axial wire segments 314 and 316 and three circumferential wire segments 318, 320 and 322. The transverse mode coil 308 can be connected to the axial mode coil 310 through the circumferential wire segments 320 and 322 so that the processed axial electromagnetic waves on the axial mode coil 310 and the processed transverse electromagnetic waves on the transverse mode coil 308 can be superimposed.

In some embodiments, the axial mode coil 310 and the transverse mode coil 308 (and/or the transverse mode coil 312) can be formed in one piece by folding a single wire into a shape with one axial loop as the axial mode coil 310 and at least one transverse loop as the transverse mode coil 308 (and/or the transverse mode coil 312).

FIG. 3C illustrates an enlarged view of the second antenna 304 shown in FIG. 3A.

The second antenna 304 can be a wire loop deployed substantially perpendicular to the longitudinal axis of the directional resistivity tool 212.

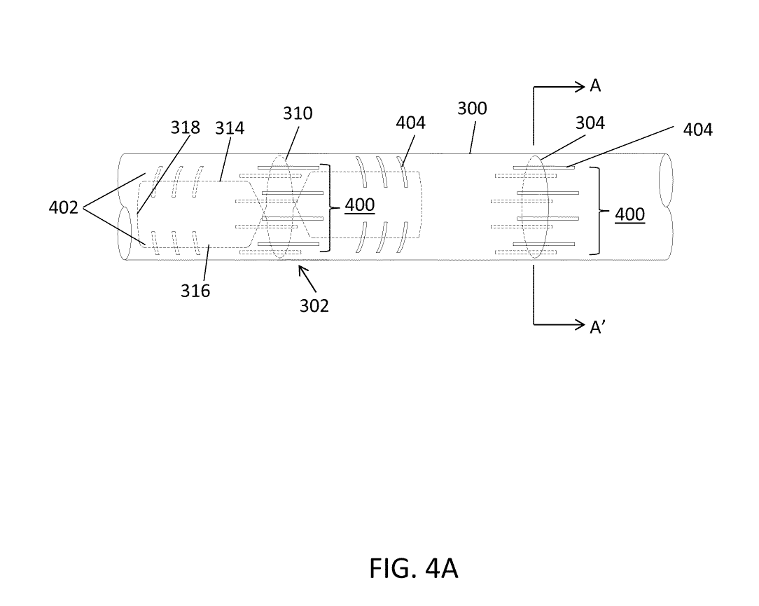

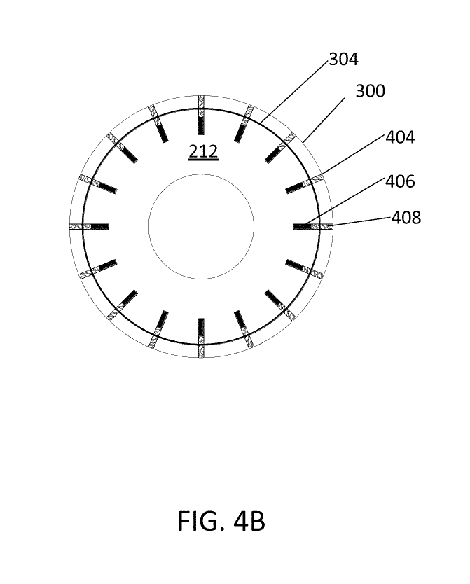

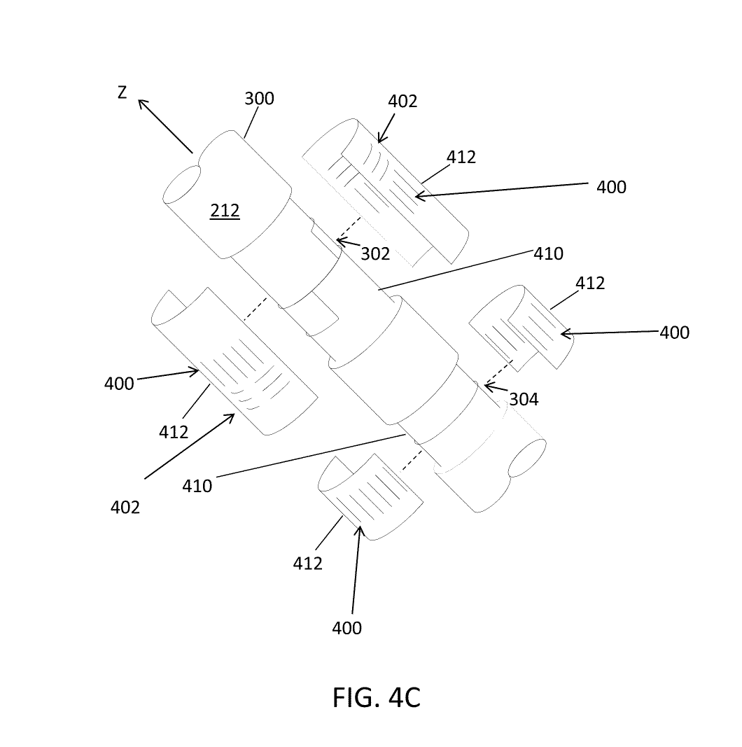

FIG. 4A illustrates a perspective view of the directional resistivity tool 212 with two sets of slots 400 and 402 according to some embodiments of the present invention. Each set of slots can have one or more slots 404 and have different orientations from each other. The first set of slots 402 can be formed in two rows and oriented substantially perpendicular to the longitudinal axis of the resistivity tool body 212 for mechanical protection of the first antenna 302 and facilitating the propagation of electromagnetic waves. The structure of the first set of slot 402, which looks like a fish-bone, can also increase the mechanical strength of the mandrel of the body of the directional resistivity tool 212. The second set of slots 400 can be oriented substantially parallel to the longitudinal axis of the directional resistivity tool 212. The pathways of the first antenna 302 and the optional third antenna 306 can traverse the two sets of slots 400 and 402 below the outer surface 300 of the directional resistivity tool 212. The pathway of the second antenna 304 can traverse the second set of slots 400 below the outer surface 300 of the directional resistivity tool 212. The intersecting structure can ensure there is no electrically conductive loop about the slots 404 and enable an antenna to transmit or receive electromagnetic field.

In some embodiments, the first set of slots 402 and the second set of slots 400 can be formed on the outer surface 300 in any orientation. In another embodiment, the second antenna 304 can be deployed below the outer surface 300 in any orientation and shape. The present invention is in no way limited to any particular geometry and number of such slots and antennas.

FIG. 4B illustrates a cross-sectional view of the directional resistivity tool taken along line AA′ in FIG. 4A. In some embodiments, a permeable material 406 can be filled in the slots 404. The permeable material 406 can be a magnetic material for enhancing transmission and reception of the antennas. The magnetic material can be, but not limited to, a ferrite material, an electrically non-conductive magnetic alloy, an iron powder, and a nickel iron alloy.

In some embodiments, a protective material 408 also can be filled in the slots 404. The protective material 408 can be for protecting the electrical instruments formed in the directional resistivity tool 212 from damages caused while drilling. The protective material can be, but not limited to, epoxy resin.

FIG. 4C illustrates an explored view of the directional resistivity tool 212 with recessed regions 410 and slot shields 412 according to another embodiment of the present invention. The first antenna 302 and the second antenna 304 can be mounted on the recessed regions 410 and covered by the slot shields 412. The two sets of slots 400 and 402 can be formed on the slot shield 412 to provide mechanical protection for antennas and paths for electromagnetic wave to be emitted out from the slot shield 412.

In FIG. 3A˜3C and FIG. 4A˜4C, the second antenna 304 acts as a transmitter antenna for transmitting electromagnetic waves and the first antenna 402 and the third antenna 306 act as receiver antennas for receiving electromagnetic waves (superimposition of the axial and transverse electromagnetic waves) from the transmitter antenna during the rotation of the directional resistivity tool 212. Such an arrangement can enable the acquisition of compensated resistivity measurements. However, in accordance with the principle of reciprocity, each antenna may be able to act as either a transmitter antenna or a receiver antenna as long as connected with appropriate transmitter or receiver electronics. Thus, the second antenna 304 can also act as a receiver antenna and the first antenna 302 and the third antenna 306 can also act as transmitter antennas. Also however, the present invention is not limited to any particular transmitter or receiver spacing, nor the use of compensated or uncompensated measurements.

In operation, the first antenna 302 with a joint-coil structure can obtain superimposition of axial and transverse electromagnetic waves through the axial mode coil 310, as a axial mode (z-mode) magnetic dipole, and through the transverse mode coils 308 and 312, as transverse mode (x-mode and/or y-mode) magnetic dipoles. The first antenna 302 with a joint-coil structure as a whole can be treated as a combination of the axial mode and transverse mode dipoles.

During drilling, when the directional resistivity tool 212 approaches a resistivity interface, the induced voltage on the axial mode coil 310 can reflect the presence of the interface (through the change of amplitude attenuation and phase shift), as known to one skilled in the art. The sinusoidal change of the induced voltages with the rotation of the directional resistivity tool 212 reflected on the transverse mode coils 308 and 312 can further tell the direction and distance from the resistivity interface. In that way, a user can distinguish the directional resistivity tool 212 is approaching a resistivity interface from above or below the resistivity interface. As a result, the total induced voltage on the first antenna 302 with a joint-coil structure can reflect not only the surrounding formation resistivity but also the location of boundary.

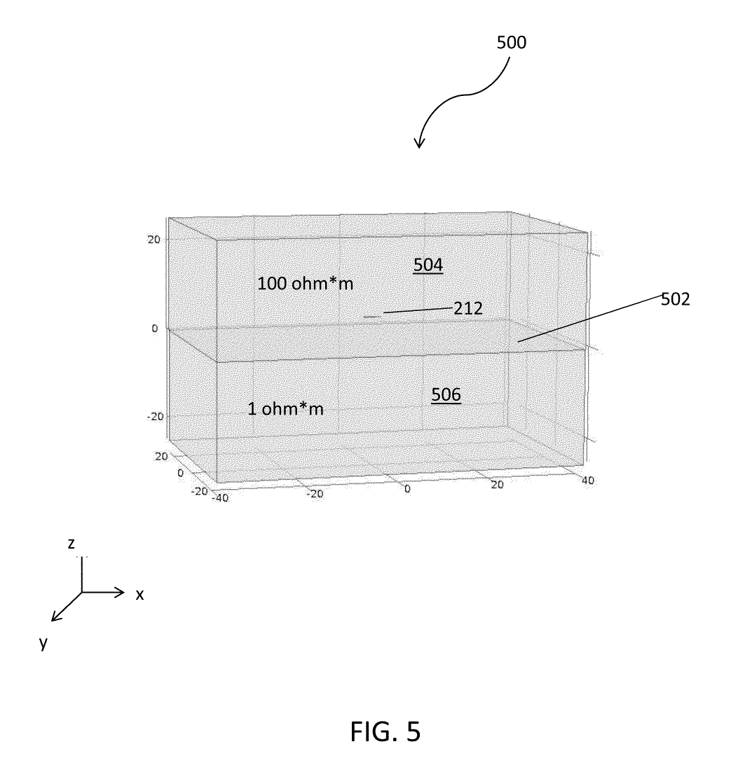

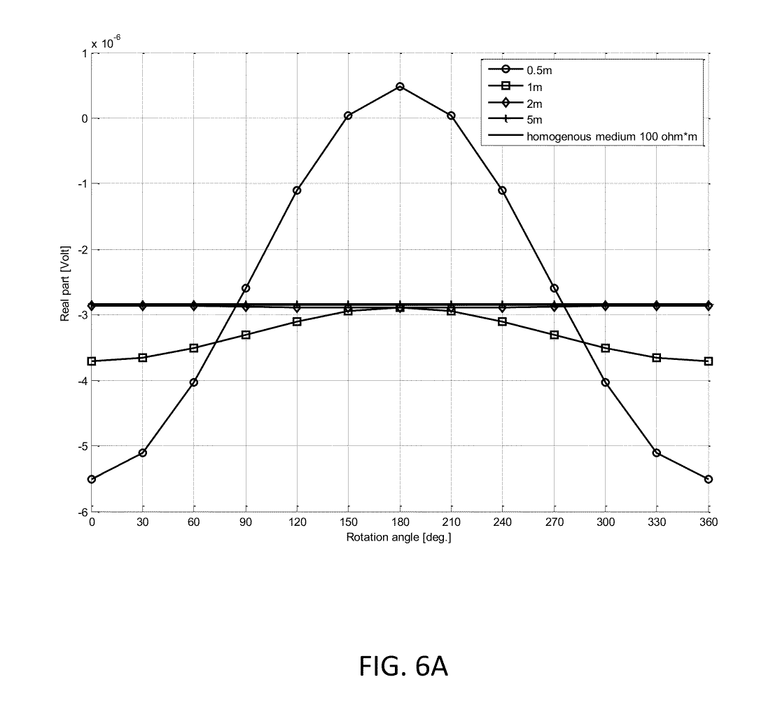

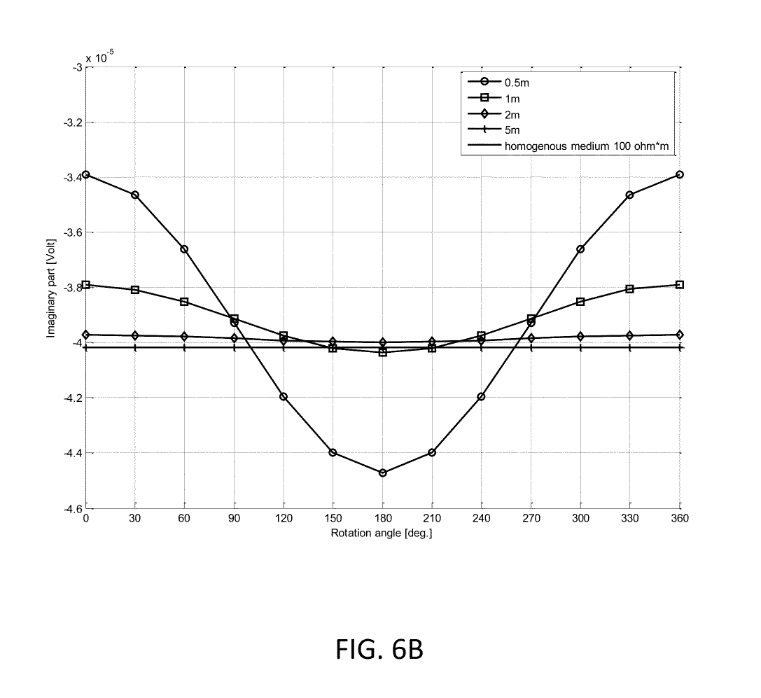

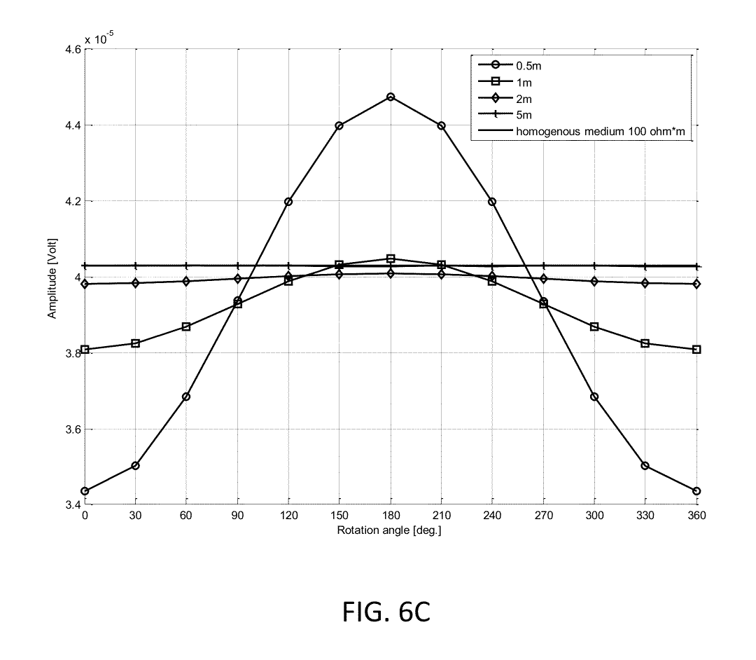

FIG. 5 illustrates an exemplary model 500 used for demonstrating the azimuthal sensitivity of the present invention, and FIGS. 6A˜C, 7A˜C, 8A˜C, and 9A˜B show simulation results of the model 500 provided in FIG. 5. In FIG. 5, the model 500 can contain a 3D cube divided into two parts by a horizontal resistivity interface 502. The upper part 504 can have a resistivity of 100 ohm*m and the lower part 506 can have a resistivity of 1 ohm*m. The directional resistivity tool 212 depicted in FIG. 3A can be placed in the upper part 504 and approaches to the resistivity interface 502 for simulation.

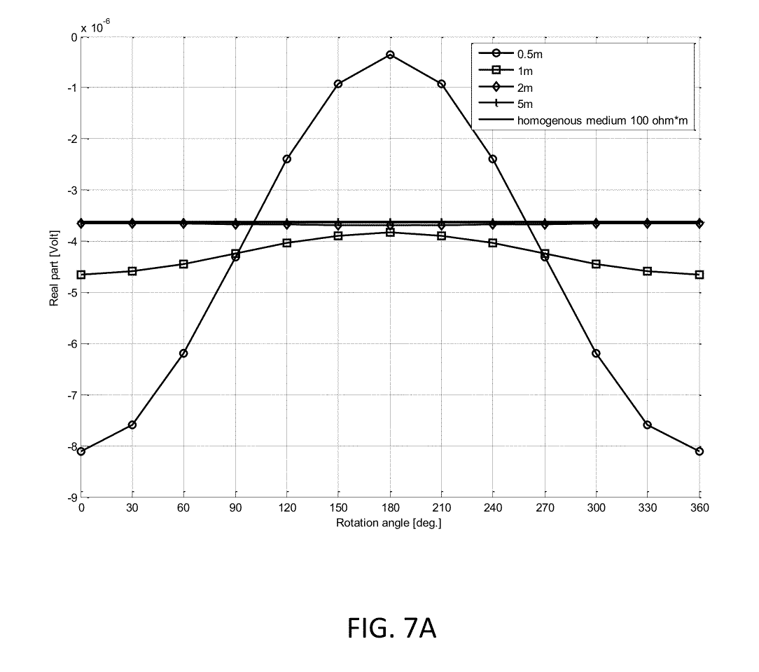

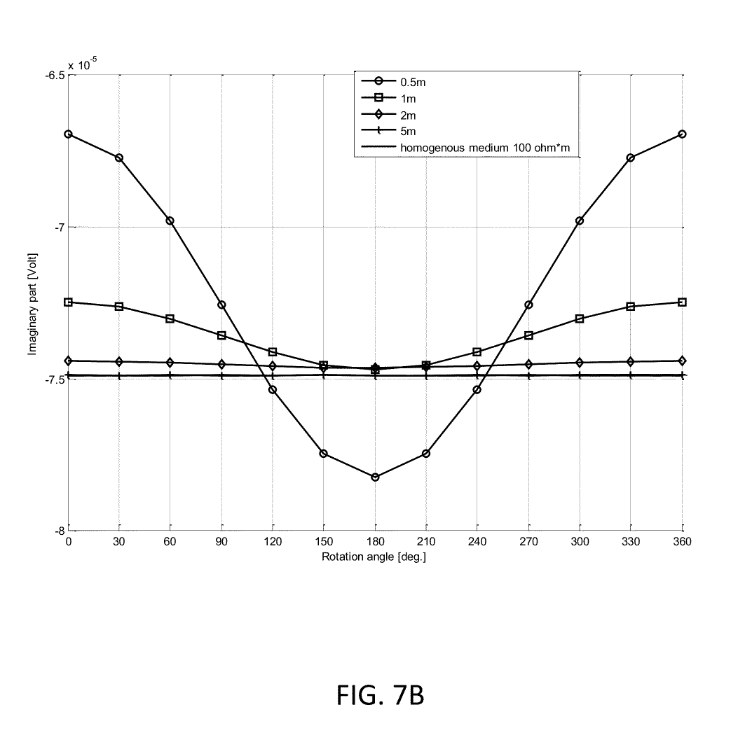

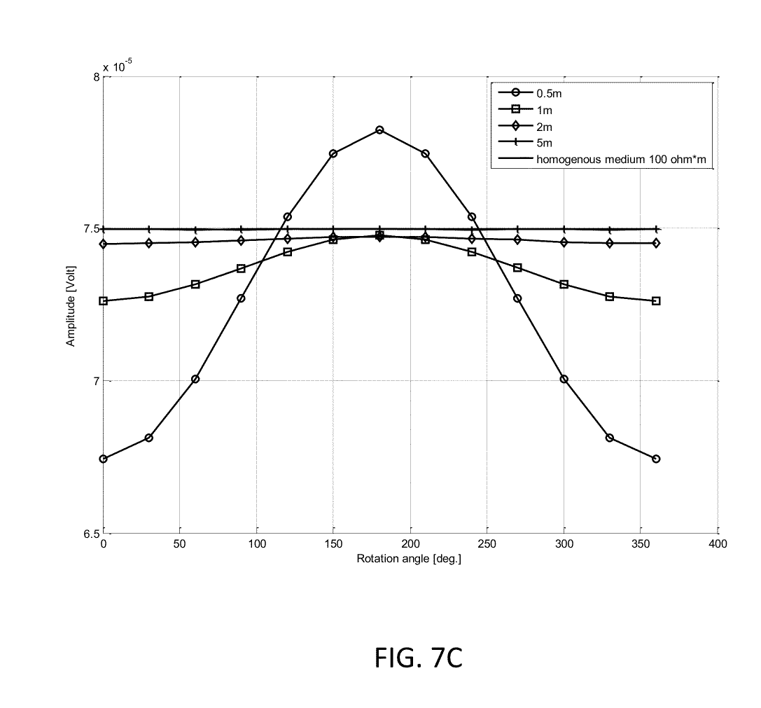

FIGS. 6A˜6C illustrate simulation results of the model 500 in FIG. 5 in terms of a data graph of the real part, the imaginary part, and the amplitude of the induced voltage of the first antenna 302 shown in FIG. 3A versus rotation angle of the directional resistivity tool 212 at different vertical distances from the directional resistivity tool 212 to the resistivity interface 502, and FIGS. 7A˜7C illustrate simulation results of the model 500 in FIG. 5 in terms of a data graph of the real part, the imaginary part, and the amplitude of the induced voltage of the third antenna 306 shown in FIG. 3A versus rotation angle of the directional resistivity tool 212 at different vertical distances from the directional resistivity tool 212 to the resistivity interface 502 according to some embodiments of the present invention. In accordance with FIGS. 6A˜C and 7A˜C, the induced voltages reflected on the first antenna 302 and the third antenna 306, both of which act as a receiver antenna, can vary sinusoidally with the rotation of the directional resistivity tool 212. The peak-valley amplitude of the sinusoidally-varying curves can be related to the distances from the directional resistivity tool 212 to the resistivity interface 502. The closer the directional resistivity tool 212 to the resistivity interface 502, the bigger the peak-valley amplitude of the sinusoidal voltage curve.

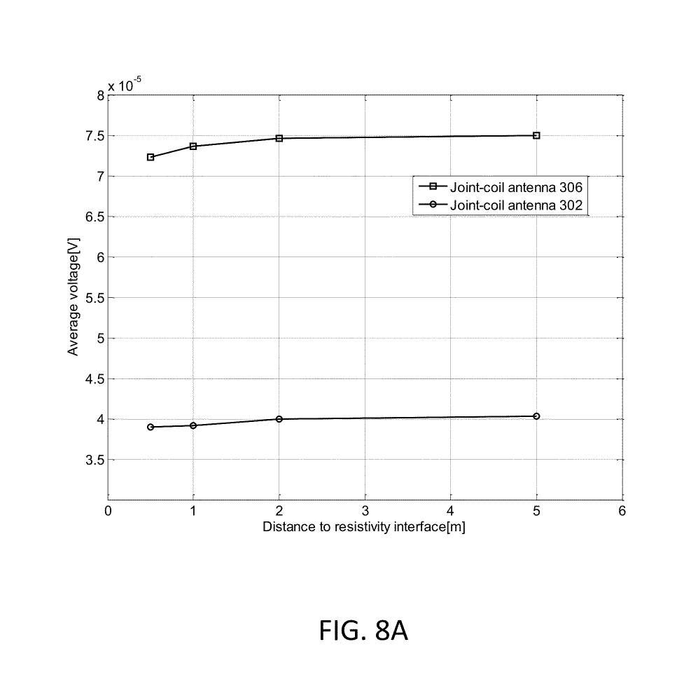

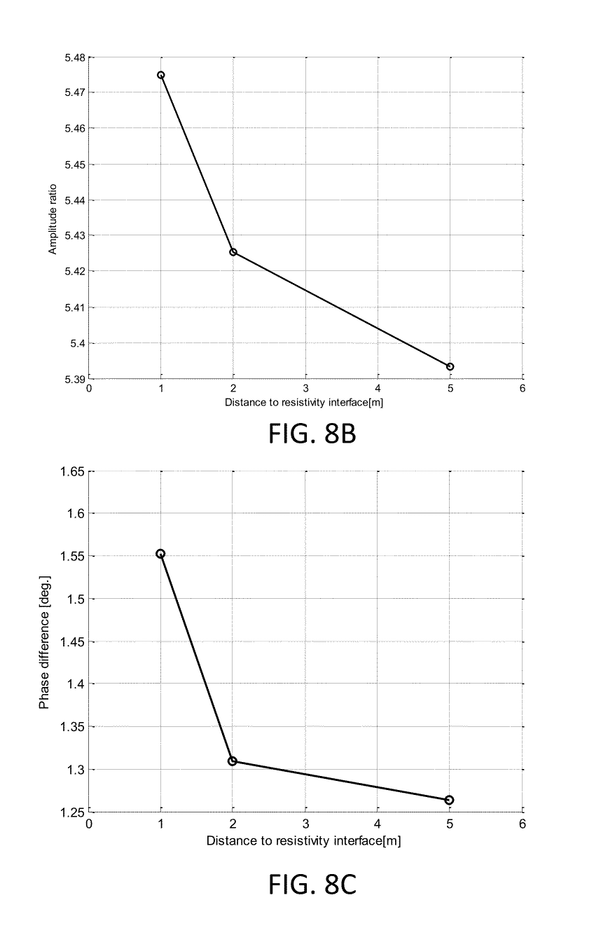

FIG. 8A illustrates simulation results of the model 500 in FIG. 5 in terms of a data graph of the average induced voltage of the first antenna 302 and of the third antenna 306 shown in FIG. 3A versus distance to resistivity interface 502. In accordance with FIG. 8A, the closer the directional resistivity tool 212 to the conductive zone 506, the smaller the average induced voltage on the receiver antennas. FIG. 8B illustrates simulation results of the model 500 in FIG. 5 in terms of a data graph of the amplitude ratio of the average induced voltage of the first antenna 302 to the average induced voltage of the third antenna 306 shown in FIG. 3A versus distance to resistivity interface 502, and FIG. 8C illustrates simulation results of the model 500 in FIG. 5 in terms of a data graph of the phase difference between the average induced voltage of the first antenna 302 and the average induced voltage of the third antenna 306 shown in FIG. 3A versus distance to resistivity interface 502. In accordance with FIGS. 8B and 8C, the closer the directional resistivity tool 212 to the conductive zone 506, the smaller both the amplitude ratio and phase difference of the average induced voltage on the receiver antennas (the dip effect is ignored within the distance interested, i.e. 1 m, 2 m and 5 m).

Above simulation results show that when the directional resistivity tool 212 is far way from the resistivity interface 502 (e.g. 5 m), the results have little difference from the result derived while the directional resistivity tool 212 is placed in a homogenous medium with a resistivity of 100 ohm*m. However, when the directional resistivity tool 212 is approaching the resistivity interface 502, the sinusoidally-varying induced voltage on the receiver antennas can be indicative of electrical properties of a surrounding subterranean formation, including, but not limited to, the distance and direction to the resistivity interface. Thus, a directional resistivity tool 212 with an antenna with a join-coil structure has azimathal sensitivity to make steering decisions for subsequent drilling of the borehole

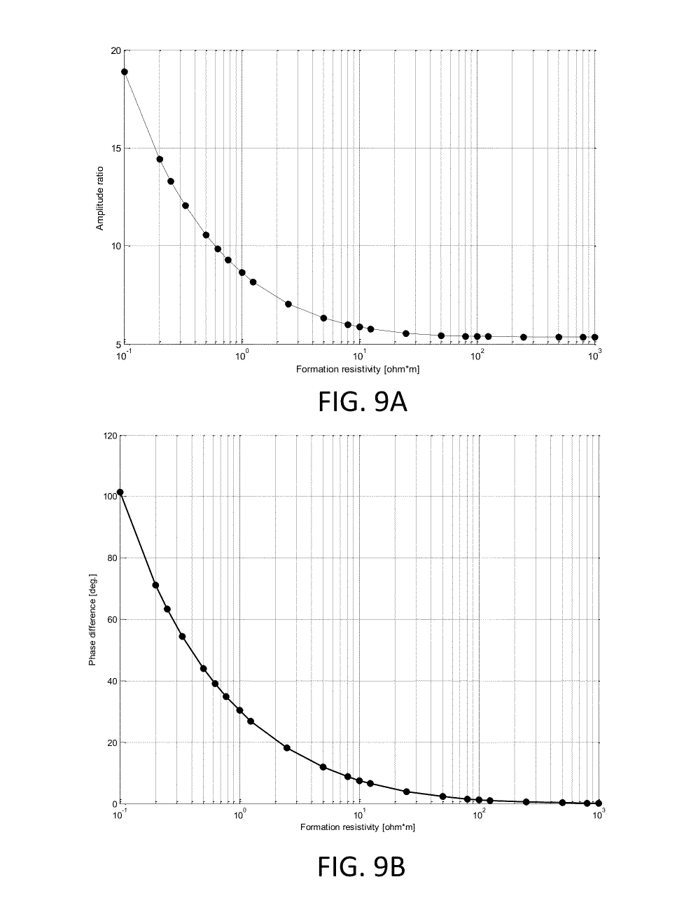

FIG. 9A illustrates simulation results of a model in which the directional resistivity tool 212 is embedded in a homogenous formation with varying resistivity in terms of a data graph of the amplitude ratio of the induced voltage of the first antenna 302 to the induced voltage of the third antenna 306 shown in FIG. 3A versus resistivity of the surrounding formation, and FIG. 9B illustrates simulation results of the model in terms of a data graph of the phase difference between the induced voltage of the first antenna 302 and the induced voltage of the third antenna 306 shown in FIG. 3A versus resistivity of surrounding formation. These simulation results are similar with the conversion charts (amplitude ratio and phase difference versus surrounding formation resistivity) for conventional LWD and/or MWD as known to one skilled in the art. Therefore, all related prior art for conventional LWD and/or MWD can be applied and referenced in some embodiments of the present invention. Based on the simulation results shown in FIGS. 8B and 8C (amplitude ratio and phase difference), the resistivity of surrounding formation can be obtained by looking up the simulation results (conversion chart) shown in FIGS. 9A and 9B. Thus, a directional resistivity tool 212 with an antenna with a join-coil structure can also be used for obtaining resistivity information of the formation adjacent to a borehole.

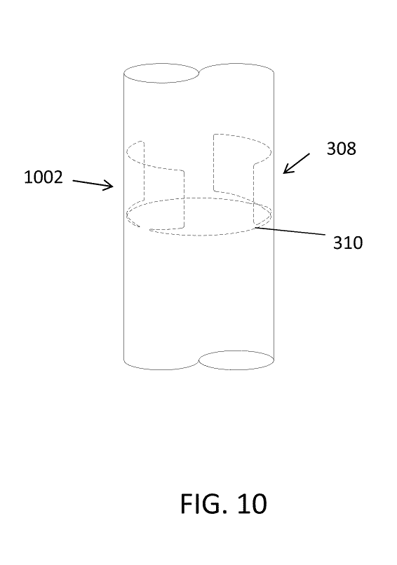

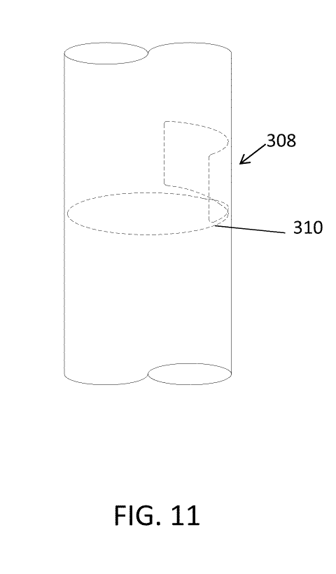

In some embodiments, the number and shape of the transverse mode coils 308 and 312 shown in FIG. 3B can be varied. In FIG. 3B, two transverse mode coils 308 and 312 extend from the connected axial mode coil 310 toward different directions (called as Z-shaped design). In FIG. 10, two transverse coils 308 and 1002 extend from the connected axial mode coil 310 toward the same direction (called as C-shaped design). The transverse coil 1002 has to be wound differently from the transverse coil 308 so as to superimpose, instead of cancelling out, the electromagnetic signals from the two transverse coils. In FIG. 11, only one transverse mode coil 308 is connected with the axial mode coil 310 (called as L-shaped design). Both of the antennas with the C-shaped and the L-shaped design can have the same functions as the Z-shaped design shown in FIG. 3B.

In some embodiments, the axial mode coil 310 and the transverse mode coil 308 (and/or the transverse mode coil 1002) can be formed in one piece by folding a single wire into a shape with one axial loop as the axial mode coil 310 and at least one transverse loop as the transverse mode coil 308 (and/or the transverse mode coil 1002).

A corresponding method for making directional resistivity measurements of a subterranean formation includes rotating a resistivity tool in a borehole, which includes a first antenna having an axial mode coil for processing an axial electromagnetic wave and a transverse mode coil for processing a transverse electromagnetic wave to form a joint-coil structure, a second antenna, and the first antenna and the second antenna forming a transmitter-receiver antenna group having a transmitter antenna and a receiver antenna; utilizing the transmitter-receiver antenna group to process a superimposition of the axial electromagnetic wave and the transverse electromagnetic wave, including causing the transmitter antenna to transmit the superimposition of the axial electromagnetic wave and the transverse electromagnetic wave and causing the receiver antenna to receive the superimposition of the axial electromagnetic wave and the transverse electromagnetic wave from the transmitter antenna; and computing a resistivity-related measurement from the superimposition of the axial electromagnetic wave and the transverse electromagnetic wave on the receiver antenna.

In some embodiments, computing the resistivity-related measurement can include extracting an average value of induced voltages on the receiver antenna during a rotation round of the resistivity tool.

In some embodiments, computing the resistivity-related measurement can further include processing the average value of induced voltages to derive a resistivity of the subterranean formation adjacent to the borehole.

In some embodiments, computing the resistivity-related measurement can include extracting a peak-valley amplitude of induced voltages on the receiver antenna during a rotation round of the resistivity tool and a rotation angle.

In some embodiments, computing the resistivity-related measurement can further include processing the peak-valley amplitude to derive information of distance and direction to an interface from the resistivity tool.

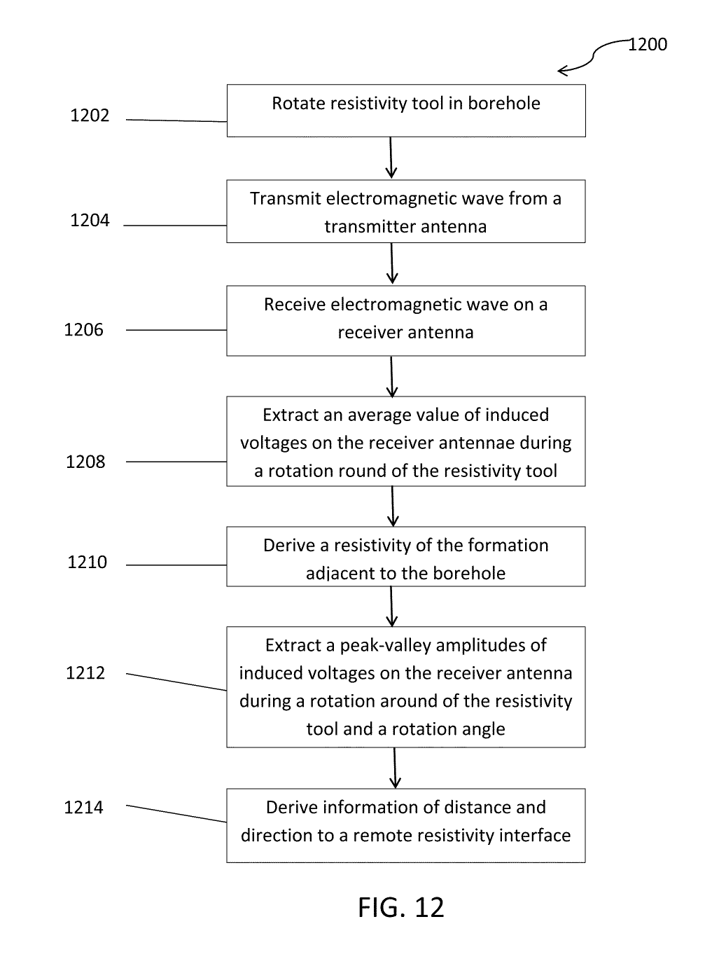

FIG. 12 illustrate of an exemplary flow chart of making directional resistivity measurements 1200 according to some embodiments of the present invention. The steps include rotating a resistivity tool in a borehole 1202, transmitting electromagnetic wave from a transmitter antenna 1204, receiving electromagnetic wave on a receiver antenna 1206, extracting an average value of induced voltages on the receiver antenna during a rotation round of the resistivity tool 1208, deriving a resistivity of the formation adjacent to the borehole 1210, extracting a peak-valley amplitude of induced voltages on the receiver antenna during a rotation round of the resistivity tool and a rotation angle 1212, and deriving information of distance and direction to a remote resistivity interface 1214. However, the present invention is in no way limited to any particular order of steps or requires any particular step illustrated in FIG. 12.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for making directional resistivity measurements of a subterranean formation comprising:
a resistivity tool with a longitudinal axis and an outer surface;
a first antenna deployed below the outer surface and having an axial mode coil and a transverse mode coil to form a joint-coil structure for processing signals; the axial mode coil having a central axis which is substantially parallel to the longitudinal axis of the resistivity tool; the transverse mode coil having a central axis which is substantially perpendicular to the longitudinal axis of the resistivity tool;
a second antenna deployed below the outer surface and spaced at an axial distance from the first antenna;
at least two sets of slots formed on the outer surface; and
wherein the first set of slots is oriented differently on the outer surface from the second set of slots.

2. The apparatus according to claim 1 wherein the axial mode coil processes an axial electromagnetic wave.

3. The apparatus according to claim 1 wherein the transverse mode coil processes a transverse electromagnetic wave.

4. The apparatus according to claim 1 wherein the joint-structure is configured in a way that the signals processed by the axial mode coil and the signals processed by the transverse mode coil are superimposed.

5. The apparatus according to claim 1 wherein the first antenna operates as a transmitter antenna to transmit an electromagnetic wave or as a receiver antenna to receive the electromagnetic wave.

6. The apparatus according to claim 5 wherein the second antenna operates as the receiver antenna while the first antenna operates as the transmitter antenna.

7. The apparatus according to claim 5 wherein the second antenna operates as the transmitter antenna while the first antenna operates as the receiver antenna.

8. The apparatus according to claim 1 wherein the second antenna is a wire loop deployed substantially perpendicular to the longitudinal axis of the resistivity tool.

9. The apparatus according to claim 1 wherein the axial mode coil is a wire loop deployed substantially perpendicular to the longitudinal axis of the resistivity tool.

10. The apparatus according to claim 1 wherein the transverse mode coil has two axial wire segments and three circumferential wire segments.

11. The apparatus according to claim 10 wherein two of the circumferential wire segments is connected with the axial mode coil.

12. The apparatus according to claim 1 wherein the second set of slots is oriented substantially parallel to the longitudinal axis of the resistivity tool.

13. The apparatus according to claim 1 wherein the first set of slots is formed in two rows and oriented substantially perpendicular to the longitudinal axis of the resistivity tool.

14. The apparatus according to claim 1 wherein the pathway of the first antenna traverses the two sets of slots.

15. The apparatus according to claim 1 further comprising a permeable material filled in the slots.

16. The apparatus according to claim 15 wherein the permeable material is a magnetic material for enhancing transmission and reception of the first antenna and the second antenna.

17. The apparatus according to claim 16 wherein the magnetic material is selected from the group consisting of a ferrite material, an electrically non-conductive magnetic alloy, an iron powder, and a nickel iron alloy.

18. The apparatus according to claim 1 further comprising a protective material filled in the slots.

19. The apparatus according to claim 18 wherein the protective material is made of epoxy resin.

20. An apparatus for making directional resistivity measurements of a subterranean formation comprising:
a resistivity tool with a longitudinal axis and at least two recessed regions;
a first antenna placed in the recessed region and having an axial mode coil and a transverse mode coil to form a joint-coil structure to receive or transmit an electromagnetic wave; the axial mode coil being for processing an axial electromagnetic wave; the transverse mode coil being for processing a transverse electromagnetic wave;
a second antenna placed in the recessed region of the resistivity tool body, spaced at an axial distance from the first antenna, and configured to transmit or receive the electromagnetic wave to or from the first antenna;
at least one slot shield having two sets of slots formed on the recessed regions to cover the first antenna and the second antenna for mechanical protection and facilitating the propagation of the electromagnetic wave; and
the first set of slots is oriented differently on the outer surface from the second set of slots.

21. A method for making directional resistivity measurements of a subterranean formation comprising:
rotating a resistivity tool in a borehole, the resistivity tool including a first antenna having an axial mode coil for processing an axial electromagnetic wave and a transverse mode coil for processing a transverse electromagnetic wave to form a joint-coil structure, a second antenna, and the first antenna and the second antenna forming a transmitter-receiver antenna group having a transmitter antenna and a receiver antenna;
utilizing the transmitter-receiver antenna group to process a superimposition of the axial electromagnetic wave and the transverse electromagnetic wave, including causing the transmitter antenna to transmit the superimposition of the axial electromagnetic wave and the transverse electromagnetic wave and causing the receiver antenna to receive the superimposition of the axial electromagnetic wave and the transverse electromagnetic wave from the transmitter antenna; and
computing a resistivity-related measurement from the superimposition of the axial electromagnetic wave and the transverse electromagnetic wave on the receiver antenna.

22. The method according to claim 21 wherein computing the resistivity-related measurement comprises extracting an average value of induced voltages on the receiver antenna during a rotation round of the resistivity tool.

23. The method according to claim 22 wherein computing the resistivity-related measurement further comprises processing the average value of induced voltages to derive a resistivity of the subterranean formation adjacent to the borehole.

24. The method according to claim 21 wherein computing the resistivity-related measurement comprises extracting a peak-valley amplitude of induced voltages on the receiver antenna during a rotation round of the resistivity tool and a rotation angle.

25. The method according to claim 24 wherein computing the resistivity-related measurement further comprises processing the peak-valley amplitude to derive an information of distance and direction to an interface from the resistivity tool.

26. An apparatus for making directional resistivity measurements of a subterranean formation comprising:
a resistivity tool with a longitudinal axis and an outer surface;
a first antenna deployed below the outer surface and formed by a single wire for processing signals, wherein the single wire is folded into a shape with at least an axial loop and at least a transverse loop; the axial loop having a central axis substantially parallel to the longitudinal axis of the resistivity tool and for processing an axial electromagnetic wave; the transverse loop having a central axis substantially perpendicular to the longitudinal axis of the resistivity tool and for processing a transverse electromagnetic wave;
a second antenna deployed below the outer surface and spaced at an axial distance from the first antenna;
at least two sets of slots formed on the outer surface; and
wherein the first set of slots is oriented differently on the outer surface from the second set of slots.
